(19) United States
(12) Patent Application Publication
(10) Pub. No.: US 2012/0308980 A1
(43) Pub. Date: Dec. 6, 2012

(54) INDIVIDUALIZED LEARNING SYSTEM

(76) Inventor: Leonard Krauss, Walnut Creek, CA (US)

(21) Appl. No.: 13/404,321

(22) Filed: Feb. 24, 2012

Related U.S. Application Data
(60) Provisional application No. 61/519,997, filed on Jun. 3, 2011.

(51) Int. Cl. G09B 7/00; G09B 3/00

(52) U.S. Cl. 434/362; 434/322

(57) ABSTRACT

A system and method for educating students such that each student can learn material individually and progress through lessons at the student's own pace. The system can present the student with different versions of each lesson for alternate explanations of the educational concepts taught by the lesson. The system can allow each student to progress to the next lesson only when the system confirms that the student understands the educational concepts taught by the lesson, and can provide additional explanations of any material the student has difficulty understanding.

### CROSS-REFERENCE TO RELATED APPLICATIONS

This application claims the benefit of priority to prior filed U.S. Provisional Patent Application No. 61/519,997, filed Jun. 3, 2011, the complete contents of which are hereby incorporated by reference.

### BACKGROUND

1. Field of the Invention

The present invention relates generally to instructing students, and in particular to a system and method for instructing students individually such that each student can utilize alternate learning materials to progress and learn independently at his or her own pace along an individualized learning path toward required learning goals.

2. Background

Traditionally, schools have gathered students in classrooms to be taught by teachers who follow lesson plans and teach material to the students as a group. For many school subjects, lessons are often presented in a particular sequence in which new lessons build on the concepts learned in previous lessons. This method can work well for students who attend class regularly and understand the material quickly enough to keep up with each new lesson. However, a student who misses a class session or has trouble understanding a lesson can fall behind when the teacher must move on to the next lesson. The student can become frustrated when a new lesson requires an understanding of previous lessons which the student missed or did not fully understand. Teachers can offer some forms of individualized instruction to students who are falling behind, but often do not have the resources to devote enough time or attention to these students to help them fully catch up because the teacher also needs to keep the rest of the students in the class engaged in the current lesson. Similarly, some students who quickly grasp the concepts of a lesson can become bored by the pace of the class group and can wish to move on to more advanced lessons, but often must wait for other students in the class to catch up before the teacher moves on to a new lesson. A class can therefore progress through the lesson plan too quickly for some students and too slowly for other students. Traditional teaching is primarily directed toward a class as a group, but learning and understanding can be achieved by each individual student according to that student's own interests and abilities.

Similar to the sequential presentation of educational concepts in a lesson plan, many classes follow a textbook approach that presents material in sections, with each subsequent section building on the material taught in previous sections. Students who fail to understand and learn the material taught in any earlier sections can have difficulty understanding later sections that require a full understanding of the earlier material.

Students can learn through a variety of learning styles, including visual learning, auditory learning, kinesthetic learning, learning through reading and writing, and other learning styles. Each student can have a personal learning style through which they learn and absorb information most effectively. However, classes are often presented only in visual and/or auditory learning styles, and textbooks and supplementary materials are generally presented only in visual and/or reading learning styles. This can cause difficulty for students who learn best through other personal learning styles.

What is needed is a system and method for providing students with options for learning through individualized learning styles or learning paths that can ensure that each student learns and understands each lesson before enabling the student to progress to the next lesson. Such a system can enable each student to learn at his or her own pace as the lesson is presented in a manner most effect to each student individually. The next lesson is not presented until the student fully understands the current lesson. Students who need more time, information, or explanation to understand a lesson can take the time they need to adequately comprehend the lesson without affecting the pace of other students who quickly grasp the lessons and wish to move on to more advanced lessons. Lessons can also be presented through a variety of alternate versions that each teach the core lesson in a different way, so that a student can choose a version or versions that the student finds most engaging or that teaches the lesson's core material in a learning style more effective for that student. The system can be used to educate students in a school environment, as well as students who are being home-schooled and/or students who are studying independently

### BRIEF DESCRIPTION OF THE DRAWINGS

FIG. 1 depicts an embodiment of a system for educating a student.

FIG. 2 depicts components of a lesson that can be used by the system.

FIG. 3 depicts a flowchart of one embodiment in which the student can access the core lesson track and parallel lesson tracks in any order.

FIG. 4 depicts a flowchart of another embodiment in which the student can access the parallel lesson tracks for assistance on particular educational concepts but must return to the core lesson track to continue to progress through the lesson.

FIG. 5 depicts a flowchart of a lesson quiz in which supplemental lessons are presented when a student answers a question incorrectly.

FIG. 6 depicts a flowchart of a lesson quiz in which the student is returned to a parallel lesson track when the student answers a question incorrectly.

FIG. 7 depicts a flowchart of a lesson quiz in which the student must accumulate a certain number of overall points in order to pass the lesson quiz.

FIG. 8 depicts a flowchart of a lesson quiz in which the student must accumulate a certain number of points for each educational concept in order to pass the lesson quiz.

FIG. 9 depicts a flowchart of an embodiment of an education system with lessons and quizzes.

FIG. 10 depicts a flowchart of an embodiment of an education system with core lessons, parallel lessons, and quizzes.

FIG. 11 depicts a computer system that can execute sequences of instructions to practice the embodiments of the system.

### DETAILED DESCRIPTION

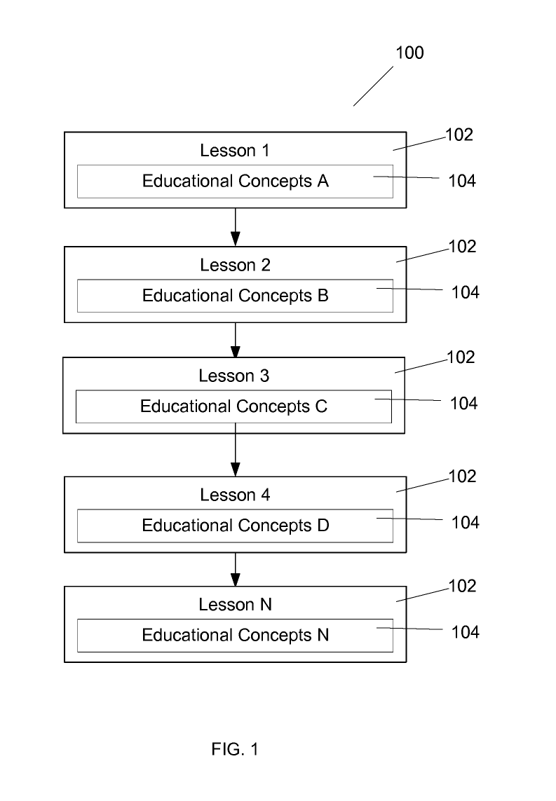

FIG. 1 depicts a system 100 for educating a student. The student can be at any level of learning, including a child who is not yet in school, an elementary school student, a high school student, a college student, an individual who desires to study a subject outside of a school, or any other type of student. In some embodiments, the system 100 can be used by a school to educate students enrolled in the school. In other embodiments, the system 100 can be used by a student outside of a school program and/or in conjunction with a school program.

The system 100 can educate the student about one or more subjects. Each subject can be any type of educational subject about which a student can desire to learn or be required to learn. Subjects can include math, science, technology, history, foreign language, or any other educational subject. Each subject can comprise one or more lessons 102. Each lesson 102 can be designed to teach one or more educational concepts 104 within the subject to the student. In some embodiments, each lesson 102 can cover the equivalent of the educational material contained in a textbook chapter. In alternate embodiments, each lesson 102 can teach one or more educational concepts 104 that cover a complete topic, a section of a topic, a subsection of a topic, an individual concept, a selection of individual concepts, or any other grouping of information. The system 100 can present each lesson 102 within each subject in a sequence, such that the student must complete a lesson 102 before the system 100 can present the next lesson 102 in the sequence. In some embodiments, subsequent lessons 102 can teach educational concepts 104 that can build on the educational concepts 104 taught by earlier lessons 102 in the sequence.

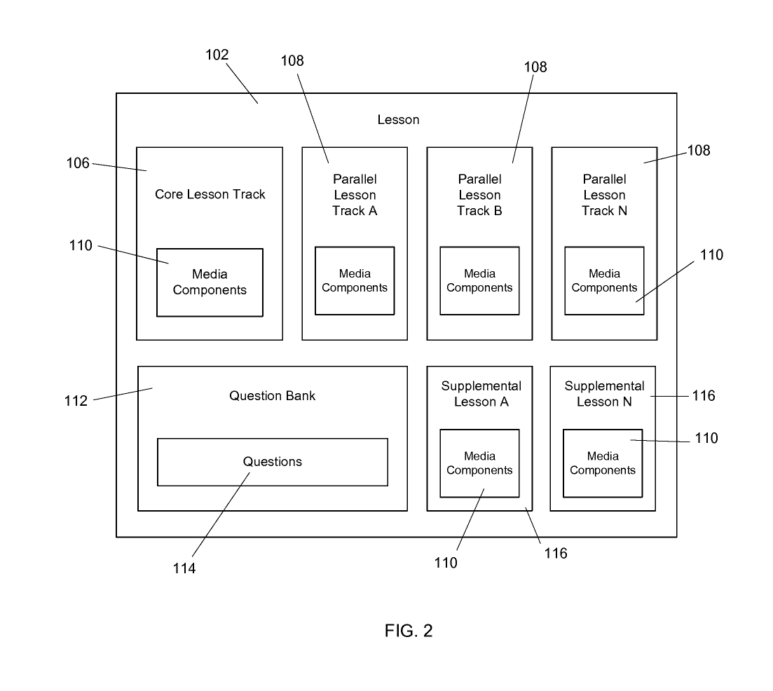

FIG. 2 depicts the components of a lesson 102 that can be used by the system 100. Each lesson 102 can comprise a core lesson track 106 and one or more parallel lesson tracks 108. The core lesson track 106 and each parallel lesson track 108 can each comprise one or more media components 110. A media component 110 can be a piece of content presented as text, audio, images, graphics, video, songs, music, animation, cartoons, games, interactive scenes, or any other type of content.

The core lesson track 106 and each parallel lesson track 108 for each particular lesson 102 can be designed to impart the same educational concepts 104 to the student through different media, methodologies and/or teaching methods. Different methodologies or teaching methods can include presenting the educational concepts 104 in a different language, at a slower pace, in a different style, through alternate forms of media, in a different format, in a presentation that emphasizes a different learning style, or by any other type of educational approach. Each parallel lesson track 108 can provide a different methodology or teaching method by using one or more media components 110 that are different than the media components 110 used by the core lesson track 106, such as by using one or more different types of media components 110, or by using one or more different versions of the same types of media components 110.

Each lesson 102 can further comprise a question bank 112. The question bank 112 can comprise one or more questions 114 designed to test the student's understanding of one or more educational concepts 104 covered by the lesson 102. Each question 114 can be a multiple choice question, fill in the blank question, true or false question, multimedia question, or any other type of question. In some embodiments, the questions 114 in the question bank 112 can be categorized by the educational concepts 104 tested by the question 114, the difficulty of the question 114, the type of question 114, or by any other criteria. In some embodiments, questions 114 can be randomly generated by the question bank 112. In some embodiments, each question 114 can have a point value corresponding to the difficulty of the question.

In some embodiments, the lesson 102 can further comprise one or more supplemental lessons 116. Each supplemental lesson 116 can comprise one or more media components 110. In some embodiments, each supplemental lesson 116 can comprise one or more media components 110 that are different than the media components 110 in the core lesson track 106 and the parallel lesson tracks 108. Each supplemental lesson 116 can be designed to teach one or more specific educational concepts 104 tested by particular questions 114 or types of questions 114. In some embodiments, each supplemental lesson 116 can teach an educational concept 104 in a different manner than the core lesson track 106 or any of the parallel lesson tracks 108. In some embodiments, each supplemental lesson 116 can teach an educational concept 104 at a deeper level than the core lesson track 106 or any of the parallel lesson tracks 108, such as by breaking a single educational concept 104 into smaller pieces that are explained individually.

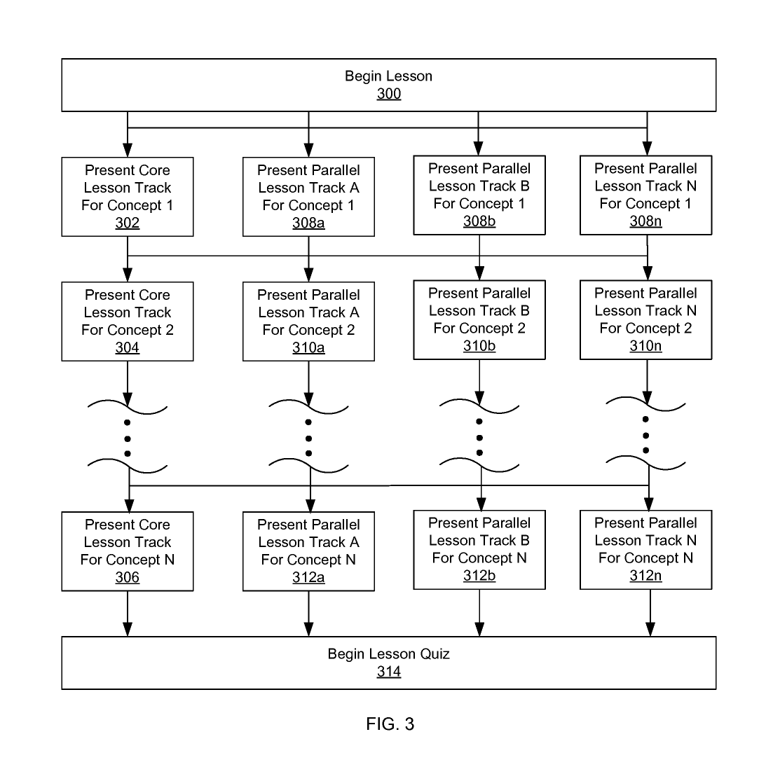

FIG. 3 depicts a flowchart of the operation of one embodiment of the system 100. At 300, the system can begin a lesson 102. In some embodiments, the system 100 can begin a lesson 102 corresponding to a specific educational subject. In some embodiments, the system 100 can begin the next lesson 102 in a sequence if the student has completed previous lessons 102 in the sequence. In some embodiments, the system 100 can begin a lesson 102 corresponding to the subject covered by a class that the student is currently attending. In alternate embodiments, the system 100 can allow the student to begin a specific lesson 102 at any time. In some embodiments, the system 100 can allow a student to begin any lesson 102 that the student has already completed. In some embodiments, the system 100 can administer an initial examination that comprises questions 114 selected from the question bank 112 in order to determine a student's knowledge level in a particular subject, such that the system 100 can allow the student to bypass preliminary lessons 102 and begin at a more advanced lesson 102 that corresponds to the student's knowledge level. In some embodiments, the system 100 can load a saved state of a lesson 102, such that the student can continue the lesson 102 from a point at which the student last interacted with the lesson 102.

At 302, 304, and 306, the system 100 can present the core lesson track 106 to the student. The student can then review and/or interact with the media components 110 of the core lesson track 106 to learn the educational concepts 104 covered by the lesson 102. In some embodiments, the system 100 can present each educational concept 104 in order, such that the student learns the educational concepts 104 linearly. By way of a non-limiting example, the system can present the core lesson track 106 for a first educational concept 104 at 302, then present the core lesson track 106 for a second educational concept 104 at 304, and continue on until the last educational concept 104 is presented in the core lesson track 106 at 306. In alternate embodiments, the system 100 can allow the student to learn nonlinearly, such that the student can learn each educational concept 104 covered by a lesson in any order the student desires. By way of a non-limiting example, a student can choose to have the system 100 present the last educational concept 104 in the core lesson track 106 at 306 first, then go back to the first educational concept 104 in the core lesson track 106 at 302, and so on. The student can choose to follow the core lesson track 106 for all the educational concepts 104 covered by the lesson. The student can also choose to have the system present one or more parallel tracks 108 for any of the educational concepts 104.

At 308, 310, and 312, the system 100 can present a parallel lesson track 108 to the student for any of the educational concepts 104. In some embodiments, the student can choose to have the system 100 present a parallel lesson track 108 at any time during the student's review of the core lesson track 106. In some embodiments, the system 100 can display a selection of choices of parallel lesson tracks 108 that the student can choose to have presented by the system 100. In some embodiments, the system 100 can automatically present a specific type of parallel lesson track 108 when the student has previously indicated a preference for that specific type of parallel lesson track 108. In some embodiments, a student's preference for a specific type of parallel lesson track 108 can be determined by the system 100 when the student consistently performs better after viewing that specific type of parallel lesson track 108. In alternate embodiments, a preference for a specific parallel lesson track 108 can have been indicated by the student through an option in a prior lesson 102, selected by the student in a settings menu, and/or determined by the system 100 through a historical pattern in which the student has consistently selected a specific type of parallel lesson track 108.

After the system 100 has presented a parallel lesson track 108, the student can then review and/or interact with the media components 110 of the parallel lesson track 106 to learn the educational concepts 104 covered by the lesson 102. In some embodiments, the student can instruct the system 100 to return to the core lesson track 106 or present a different parallel lesson track 108 at any time during the student's review of the parallel lesson track 108. In alternate embodiments, the student can instruct the system 100 to return to the core lesson track 106 or present a different parallel lesson track 108 at the completion of the parallel lesson track 108.

The student can choose to have the system 100 present a parallel lesson track 108 for any reason. By way of a non-limiting example, a student who understands Spanish better than English can choose to access a parallel lesson track 108 that comprises media components 110 presented in Spanish rather than follow a core lesson track 106 presented in English. By way of another non-limiting example, a student who learns most effectively through an auditory learning style can choose to access a parallel lesson track 108 that comprises audio media components 110. By way of an additional non-limiting example, a student who becomes bored by the core lesson track 106 can choose to access a parallel lesson track 108 that presents the same educational concepts 104 in a manner more entertaining to the student, such as through a video media component 110 that incorporates a cartoon character.

In some embodiments, the system 100 can present a parallel lesson track 108 as a supplement to the core lesson track 106, such that the student must complete the core lesson track 106 in addition to the parallel lesson track 108. By way of a non-limiting example, if a student chooses to have the system 100 present a parallel lesson track “B” the system can present the educational concepts at steps 308b, 310b, and through to 312b, and then return the student to step 302 to follow the core lesson track 106.

In some embodiments, the system 100 can allow the student to access a parallel lesson track 108 for assistance on a particular educational concept 104 within the lesson 102, and then allow the student to choose to return to the core lesson track 106 or the parallel lesson track 108, or access a different parallel lesson track 108. By way of a non-limiting example, the system 100 can allow a student to access the core lesson track at 302, move to a parallel lesson track at 308b for assistance with the first educational concept 104, and then move to another parallel lesson track at 308a for additional assistance on the same educational concept 104, return to the core lesson track for the same educational concept 104 at 302, or move on to the next educational concept 104 in the same parallel lesson track at 310b.

In some embodiments, in addition to the core lesson track 106 and the parallel lesson tracks 108, the system 100 can allow the student to access the internet to view materials related to the educational concepts 104 covered by the lesson 102. In some embodiments, the system 100 can allow limited internet access that can restrict the student to visiting only specific preapproved web sites.

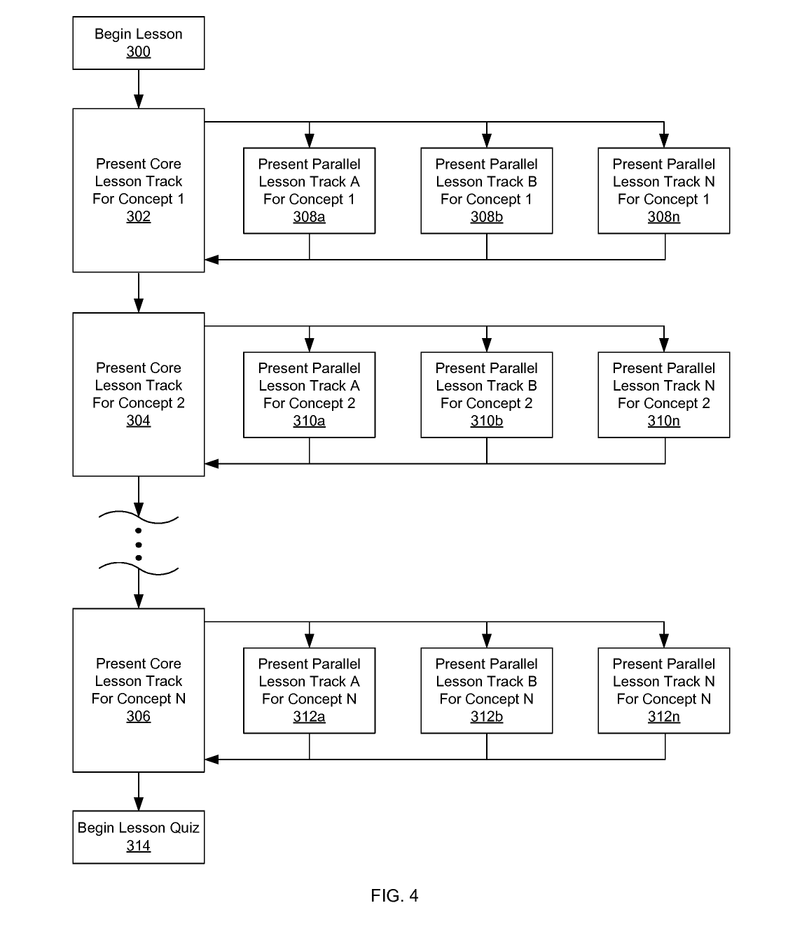

FIG. 4 depicts a flowchart of the operation of a different embodiment of the system 100. At 300, the system can begin a lesson 102. In some embodiments, the system 100 can begin a lesson 102 corresponding to a specific educational subject. In some embodiments, the system 100 can begin the next lesson 102 in a sequence if the student has completed previous lessons 102 in the sequence. In some embodiments, the system 100 can begin a lesson 102 corresponding to the subject covered by a class that the student is currently attending. In alternate embodiments, the system 100 can allow the student to begin a specific lesson 102 at any time. In some embodiments, the system 100 can allow a student to begin any lesson 102 that the student has already completed. In some embodiments, the system 100 can administer an initial examination that comprises questions 114 selected from the question bank 112 in order to determine a student's knowledge level in a particular subject, such that the system 100 can allow the student to bypass preliminary lessons 102 and begin at a more advanced lesson 102 that corresponds to the student's knowledge level. In some embodiments, the system 100 can load a saved state of a lesson 102, such that the student can continue the lesson 102 from a point at which the student last interacted with the lesson 102.

At 302, 304, and 306, the system 100 can present the core lesson track 106 to the student. The student can then review and/or interact with the media components 110 of the core lesson track 106 to learn the educational concepts 104 covered by the lesson 102. In some embodiments, the system 100 can present each educational concept 104 in order, such that the student learns the educational concepts 104 linearly. By way of a non-limiting example, the system can present the core lesson track 106 for a first educational concept 104 at 302, then present the core lesson track 106 for a second educational concept 104 at 304, and continue on until the last educational concept 104 is presented in the core lesson track 106 at 306. In alternate embodiments, the system 100 can allow the student to learn nonlinearly, such that the student can learn each educational concept 104 covered by a lesson in any order the student desires. By way of a non-limiting example, a student can choose to have the system 100 present the last educational concept 104 in the core lesson track 106 at 306 first, then go back to the first educational concept 104 in the core lesson track 106 at 302, and so on. The student can choose to follow the core lesson track 106 for all the educational concepts 104 covered by the lesson. The student can also choose to have the system present one or more parallel tracks 108 for additional or alternate explanation of any of the educational concepts 104, and then return to the core lesson track 106 to move on to the next educational concept 104.

At 308, 310, and 312, the system 100 can present a parallel lesson track 108 to the student for an educational concept 104. In some embodiments, the student can choose to have the system 100 present a parallel lesson track 108 at any time during the student's review of the core lesson track 106. In some embodiments, the system 100 can display a selection of choices of parallel lesson tracks 108 that the student can choose to have presented by the system 100 that corresponds to the educational concept 104 that the student is currently reviewing in the core lesson track 106.

After the system 100 has presented a parallel lesson track 108, the student can then review and/or interact with the media components 110 of the parallel lesson track 106 to learn the educational concept 104. The student can then instruct the system 100 to return to the core lesson track 106 such that the student can then move on to the next educational concept 104. By way of a non-limiting example, a student who is reviewing the second educational concept 104 in the core lesson track at step 304 can choose to have the system present a parallel lesson track 108 that also covers the second educational concept 104 at 310b. After reviewing the second educational concept 104 at 310b, the student can be returned to the core lesson track 106 at 304 so that the student can move on to the next educational concept 104 in the core lesson track 106.

The student can choose to have the system 100 present a parallel lesson track 108 for any reason. By way of a non-limiting example, a student who understands Spanish better than English can choose to access a parallel lesson track 108 that comprises media components 110 presented in Spanish rather than follow a core lesson track 106 presented in English. By way of another non-limiting example, a student who learns most effectively through an auditory learning style can choose to access a parallel lesson track 108 that comprises audio media components 110. By way of an additional non-limiting example, a student who becomes bored by the core lesson track 106 can choose to access a parallel lesson track 108 that presents the same educational concepts 104 in a manner more entertaining to the student, such as through a video media component 110 that incorporates a cartoon character.

In some embodiments, in addition to the core lesson track 106 and the parallel lesson tracks 108, the system 100 can allow the student to access the internet to view materials related to the educational concepts 104 covered by the lesson 102. In some embodiments, the system 100 can allow limited internet access that can restrict the student to visiting only specific preapproved web sites.

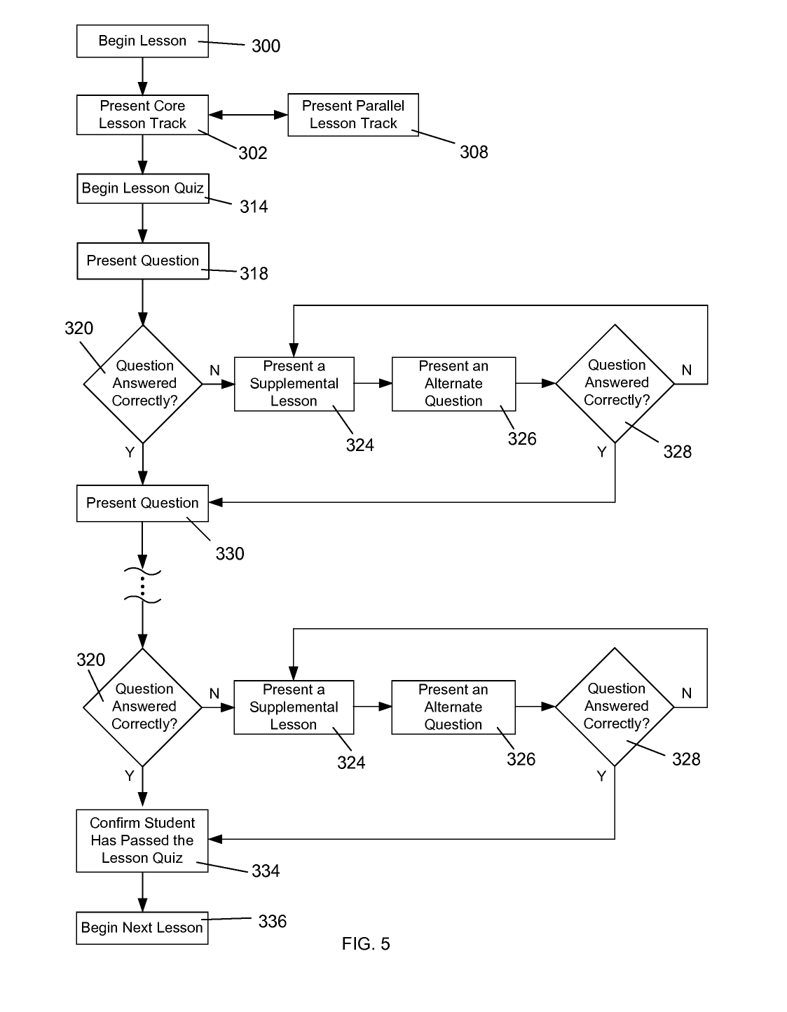

FIG. 5 depicts a flowchart of an embodiment of a lesson quiz. After the student has begun the lesson 102 at 300, reviewed the educational concepts 104 using the core lesson track at 302 and/or the parallel lesson tracks at 308 according to FIG. 3 or 4, the system can begin a lesson quiz at 314. In some embodiments, the student can choose when to have the system 100 present the lesson quiz. In alternate embodiments, the system 100 can present the lesson quiz when the system 100 determines that the student has reviewed all or a sufficient number of the media components 110 and/or educational concepts 104 in the core lesson track 106 and/or the parallel lesson tracks 108.

At 318 the system 100 can present a question 114 to the student. In some embodiments, the system 100 can select questions 114 at random from the question bank 112. In alternate embodiments, at 314 the system 100 can present preselected questions 114 for the lesson quiz for a particular lesson 102. In some embodiments in which the questions 114 in the lesson quiz have been preselected, the questions 114 can be presented in a random order. In some embodiments, the lesson quiz can comprise questions 114 such that the student must answer at least one question 114 that relates to each educational concept 104 covered by the lesson 102.

At 320, the system 100 can determine whether the student has answered the question 114 correctly. In some embodiments, the system 100 can present feedback to the student regarding the student's answer to each question 114. In some embodiments, the system 100 can present positive feedback to the student when the student answers a question 114 correctly. In some embodiments, the system 100 can inform the student when the student answers a question 114 incorrectly. In some embodiments, the system 100 can present an explanation to the student when the student answers a question incorrectly.

If the student has answered the question 114 correctly, the system can move to 330 and present the next question 114 in the lesson quiz. If the student has not answered the question 114 correctly, the system can move to 324 and present a supplemental lesson 116 to the student. The supplemental lesson 116 presented to the student can be configured to provide the student with further instruction or alternative explanations of the educational concepts 104 tested by the question 114 that the student answered incorrectly.

At 326, the system 100 can present the student with an alternate question 114 selected from the question bank 112 that covers the same educational concepts 104 that were taught by the supplemental lesson 116 and were tested by the question 114 that the student answered incorrectly. At 328, the system 100 can determine whether the student has answered the alternate question 114 correctly. If the student has answered the alternate question 114 correctly, the system can move to 330 and present the next question 114 in the lesson quiz. If the student has not answered the alternate question 114 correctly, the system can move to 324 and present a supplemental lesson 116 to the student. In some embodiments, the supplemental lesson 116 can be the same supplemental lesson 116 the student has already completed. In alternate embodiments, the supplemental lesson 116 can be a different supplemental lesson that covers the same educational concepts. In some embodiments, the system 100 can impose a time limit such that the student must spend a minimum amount of time studying the supplemental lesson 116 before attempting to answer an alternate question 114. In some embodiments, if a student repeats the supplemental lessons 116 multiple times and has difficulty answering alternate questions correctly at 326 and 328, the system 100 can transmit a message to a teacher or school official to signal that the student may need additional assistance outside of the system 100.

At 330, when the student has answered an initial question correctly at 320 or an alternate question correctly at 328, the system can present the next question 114 in the lesson quiz. At 334, once the student has answered questions 114 relating to all the educational concepts 102 correctly, either through initial questions at 320 or alternate questions at 328, the system can confirm that the student has passed the lesson quiz, and the system 100 can begin the next lesson 102 in the sequence at 336.

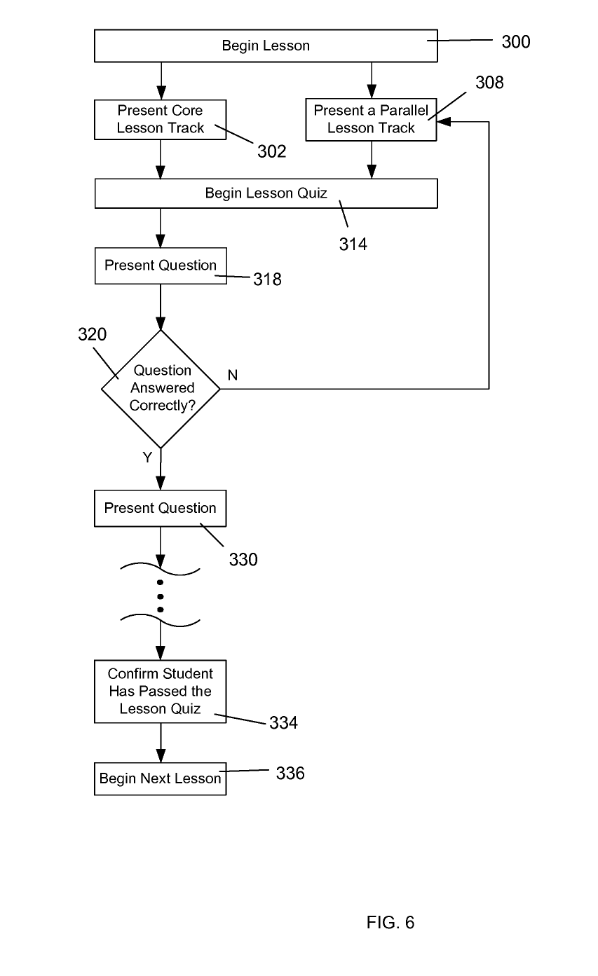

FIG. 6 depicts a flowchart of a different embodiment of a lesson quiz. After the student has begun the lesson 102 at 300, reviewed the educational concepts 104 using the core lesson track at 302 and/or the parallel lesson tracks at 308 according to FIG. 3 or 44, the system can begin a lesson quiz at 314. In some embodiments, the student can choose when to have the system 100 present the lesson quiz. In alternate embodiments, the system 100 can present the lesson quiz when the system 100 determines that the student has reviewed all or a sufficient number of the media components 110 and/or educational concepts 104 in the core lesson track 106 and/or the parallel lesson tracks 108.

At 318 the system 100 can present a question 114 to the student. In some embodiments, the system 100 can select questions 114 at random from the question bank 112. In alternate embodiments, at 314 the system 100 can present preselected questions 114 for the lesson quiz for a particular lesson 102. In some embodiments in which the questions 114 in the lesson quiz have been preselected, the questions 114 can be presented in a random order. In some embodiments, the lesson quiz can comprise questions 114 such that the student must answer at least one question 114 that relates to each educational concept 104 covered by the lesson 102.

At 320, the system 100 can determine whether the student has answered the question 114 correctly. In some embodiments, the system 100 can present feedback to the student regarding the student's answer to each question 114. In some embodiments, the system 100 can present positive feedback to the student when the student answers a question 114 correctly. In some embodiments, the system 100 can inform the student when the student answers a question 114 incorrectly. In some embodiments, the system 100 can present an explanation to the student when the student answers a question incorrectly.

If the student has answered the question 114 correctly, the system can move to 330 and present the next question 114 in the lesson quiz. If the student has not answered the question 114 correctly, the system can return to step 308 and present a parallel lesson track 108 to the student. The parallel lesson track 108 presented to the student can be configured to provide the student with further instruction or alternative explanations of the educational concepts 104 tested by the question 114 that the student answered incorrectly. In some embodiments the parallel lesson track 108 can be a parallel lesson track 108 that the student already reviewed before beginning the lesson quiz. In alternate embodiments, the parallel lesson track 108 can be a parallel lesson track 108 that the student has not yet reviewed. In some embodiments, the system 100 can allow the student to retry the lesson quiz after the student reviews the parallel lesson track 108. In other embodiments, after the student reviews the parallel lesson track 108 the system 100 can allow the student to return to the lesson quiz at the point at which the student was moved to the parallel lesson track 108. In some embodiments, the system 100 can impose a time limit such that the student must spend a minimum amount of time studying the parallel lesson track 108 before attempting the lesson quiz again. In some embodiments, if a student is returned to a parallel lesson track 108 multiple times and has difficulty finishing the lesson quiz without being returned to a parallel lesson track 108, the system 100 can transmit a message to a teacher or school official to signal that the student may need additional assistance outside of the system 100.

At 330, when the student has answered an question correctly at 320 the system can present the next question 114 in the lesson quiz. At 334, once the student has correctly answered questions 114 relating to all the educational concepts 104 the system 100 can confirm that the student has passed the lesson quiz, and the system 100 can begin the next lesson 102 in the sequence at 336.

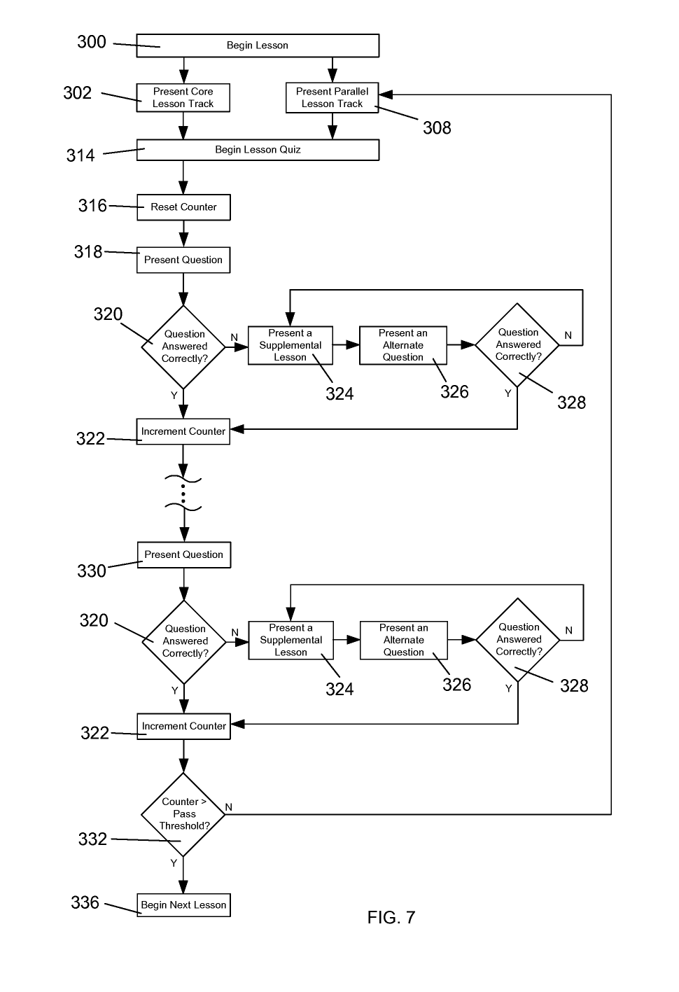

FIG. 7 depicts a flowchart of a different embodiment of a lesson quiz in which the student must accumulate a certain number of overall points before the student is allowed to move to the next lesson 102. After the student has begun the lesson 102 at 300, reviewed the educational concepts 104 using the core lesson track at 302 and/or the parallel lesson tracks at 308 according to FIG. 3 or 4, the system can begin a lesson quiz at 314. In some embodiments, the student can choose when to have the system 100 present the lesson quiz. In alternate embodiments, the system 100 can present the lesson quiz when the system 100 determines that the student has reviewed all or a sufficient number of the media components 110 and/or educational concepts 104 in the core lesson track 106 and/or the parallel lesson tracks 108.

At 316 the system can reset a counter to zero. In this embodiment, the counter can be a data field that tracks the accumulation of points for the lesson overall. The counter can be incremented when the student answers a question 114 correctly.

At 318 the system 100 can present a question 114 to the student. In some embodiments, the system 100 can select questions 114 at random from the question bank 112. In alternate embodiments, at 314 the system 100 can present preselected questions 114 for the lesson quiz for a particular lesson 102. In some embodiments in which the questions 114 in the lesson quiz have been preselected, the questions 114 can be presented in a random order. In some embodiments, the lesson quiz can comprise questions 114 such that the student must answer at least one question 114 that relates to each educational concept 104 covered by the lesson 102.

At 320, the system 100 can determine whether the student has answered the question 114 correctly. In some embodiments, the system 100 can present feedback to the student regarding the student's answer to each question 114. In some embodiments, the system 100 can present positive feedback to the student when the student answers a question 114 correctly. In some embodiments, the system 100 can inform the student when the student answers a question 114 incorrectly. In some embodiments, the system 100 can present an explanation to the student when the student answers a question incorrectly.

If the student has answered the question 114 correctly, the system 100 can move to 322 and increment the counter. If the student has not answered the question 114 correctly, the system 100 can move to 324 and present a supplemental lesson 116 to the student. The supplemental lesson 116 presented to the student can be configured to provide the student with further instruction or alternative explanations of the educational concepts 104 tested by the question 114 that the student answered incorrectly.

At 326, the system 100 can present the student with an alternate question 114 selected from the question bank 112 that covers the same educational concepts 104 that were taught by the supplemental lesson 116 and were tested by the question 114 that the student answered incorrectly. At 328, the system 100 can determine whether the student has answered the alternate question 114 correctly. If the student has answered the alternate question 114 correctly, the system can move to 322 and increment the counter. If the student has not answered the alternate question 114 correctly, the system can move to 324 and present a supplemental lesson 116 to the student. In some embodiments, the supplemental lesson 116 can be the same supplemental lesson 116 the student has already completed. In alternate embodiments, the supplemental lesson 116 can be a different supplemental lesson that covers the same educational concepts. In some embodiments, the system 100 can impose a time limit such that the student must spend a minimum amount of time studying the supplemental lesson 116 before attempting to answer an alternate question 114. In some embodiments, if a student repeats the supplemental lessons 116 multiple times and has difficulty answering alternate questions correctly at 326 and 328, the system 100 can transmit a message to a teacher or school official to signal that the student may need additional assistance outside of the system 100.

At 322, when the student has answered an initial question correctly at 320 or an alternate question correctly at 328, the system 100 can increment the counter. In some embodiments, the system 100 can increment the counter by one point for each question 114 answered correctly. In other embodiments, each question 114 can have a point value, and the system 100 can increment the counter by the point value of the question 114 answered correctly. In some embodiments, the point value can be related to the difficulty of the question 114, such that difficult questions 114 have higher point values than less difficult questions 114. After the student answers a question 114 correctly and the counter is incremented, the system 100 can move to 330 and present the next question 114 in the lesson quiz.

At 332, the system 100 can determine if the counter has been incremented above a pass threshold value by the end of the lesson quiz. The pass threshold value can be a minimum number of points a student must accumulate before the system 100 can allow the student to finish the lesson 102. If the system 100 determines that the counter is above the pass threshold value, the system 100 can move to 336 and begin the next lesson 102. In some embodiments, if the system 100 determines that the counter is not above the pass threshold value, the system 100 can return the student to a parallel track at 308 for further study of the lesson 102. The student can then restart the lesson quiz at 314. In alternate embodiments, if the system 100 determines that the counter is not above the pass threshold value, the system 100 can continue presenting questions 114 until the student correctly answers enough questions 114 to increment the counter above the pass threshold value.

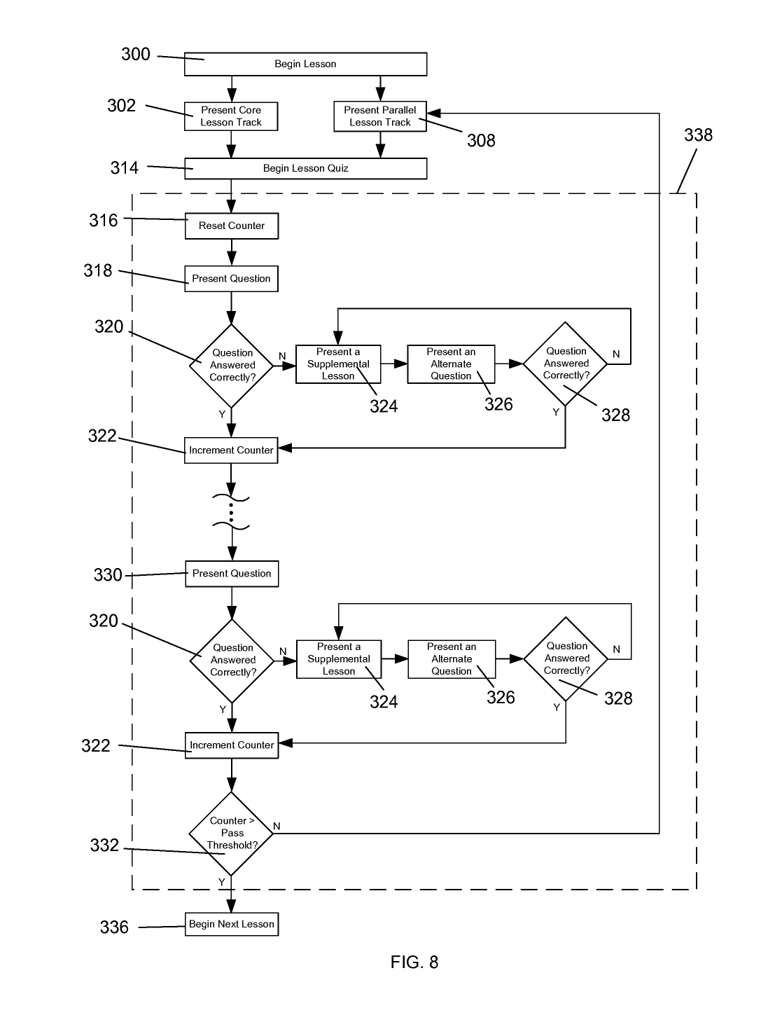

FIG. 8 depicts a flowchart of a different embodiment of a lesson quiz in which the student must accumulate a certain number of points for each educational concept 104 covered by the lesson 102 before the student can move to the next lesson 102. After the student has begun the lesson 102 at 300, reviewed the educational concepts 104 using the core lesson track at 302 and/or the parallel lesson tracks at 308 according to FIG. 3 or 4, the system can begin a lesson quiz at 314. In some embodiments, the student can choose when to have the system 100 present the lesson quiz. In alternate embodiments, the system 100 can present the lesson quiz when the system 100 determines that the student has reviewed all or a sufficient number of the media components 110 and/or educational concepts 104 in the core lesson track 106 and/or the parallel lesson tracks 108.

At 316 the system can reset a counter for each educational concept 104 covered by the lesson 102 to zero. In this embodiment, each counter can be a data field that tracks the accumulation of points for a particular educational concept 104. The counter can be incremented when the student correctly answers a question 114 relating to that educational concept 104.

At 318 the system 100 can present a question 114 to the student. In some embodiments, the system 100 can select questions 114 at random from the question bank 112. In alternate embodiments, at 314 the system 100 can present preselected questions 114 for the lesson quiz for a particular lesson 102. In some embodiments in which the questions 114 in the lesson quiz have been preselected, the questions 114 can be presented in a random order. In some embodiments, the lesson quiz can comprise questions 114 such that the student must answer at least one question 114 that relates to each educational concept 104 covered by the lesson 102.

At 320, the system 100 can determine whether the student has answered the question 114 correctly. In some embodiments, the system 100 can present feedback to the student regarding the student's answer to each question 114. In some embodiments, the system 100 can present positive feedback to the student when the student answers a question 114 correctly. In some embodiments, the system 100 can inform the student when the student answers a question 114 incorrectly. In some embodiments, the system 100 can present an explanation to the student when the student answers a question incorrectly.

If the student has answered the question 114 correctly, the system 100 can move to 322 and increment the counter for the educational concept 104 tested by the question 114. If the student has not answered the question 114 correctly, the system 100 can move to 324 and present a supplemental lesson 116 to the student. The supplemental lesson 116 presented to the student can be configured to provide the student with further instruction or alternative explanations of the educational concepts 104 tested by the question 114 that the student answered incorrectly.

At 326, the system 100 can present the student with an alternate question 114 selected from the question bank 112 that covers the same educational concepts 104 that were taught by the supplemental lesson 116 and were tested by the question 114 that the student answered incorrectly. At 328, the system 100 can determine whether the student has answered the alternate question 114 correctly. If the student has answered the alternate question 114 correctly, the system can move to 322 and increment the counter for the educational concept 104 tested by the question. If the student has not answered the alternate question 114 correctly, the system can move to 324 and present a supplemental lesson 116 to the student. In some embodiments, the supplemental lesson 116 can be the same supplemental lesson 116 the student has already completed. In alternate embodiments, the supplemental lesson 116 can be a different supplemental lesson that covers the same educational concept 104. In some embodiments, the system 100 can impose a time limit such that the student must spend a minimum amount of time studying the supplemental lesson 116 before attempting to answer an alternate question 114. In some embodiments, if a student repeats the supplemental lessons 116 multiple times and has difficulty answering alternate questions correctly at 326 and 328, the system 100 can transmit a message to a teacher or school official to signal that the student may need additional assistance outside of the system 100.

At 322, when the student has answered an initial question correctly at 320 or an alternate question correctly at 328, the system 100 can increment the counter for the educational concept 104 tested by the question 114. In some embodiments, the system 100 can increment the counter by one point for each question 114 answered correctly. In other embodiments, each question 114 can have a point value, and the system 100 can increment the counter by the point value of the question 114 answered correctly. In some embodiments, the point value can be related to the difficulty of the question 114, such that difficult questions 114 have higher point values than less difficult questions 114. After the student answers a question 114 correctly and the counter is incremented, the system 100 can move to 330 and present the next question 114 in the lesson quiz. The next question 114 can be designed to test the same educational concept 104 as the previous question 114, or can be designed to test a different educational concept 104.

At 332, the system 100 can determine if the counter for a particular educational concept 104 has been incremented above a pass threshold value at the end of the lesson quiz. The pass threshold value can be a minimum number of points a student must accumulate for each educational concept 104 before the system 100 can allow the student to finish the lesson 102. In some embodiments, each educational concept 104 covered by the lesson 102 can have the same pass threshold value. In alternate embodiments, each educational concept 104 covered by the lesson 102 can have a different pass threshold value. In some embodiments, as shown by 338, the system 100 can repeat the process from 316 to 332 for each educational concept 104 covered by the lesson 102. In alternate embodiments, the system 100 can present questions 114 related to different educational concepts 104 in any order during the lesson quiz. In these embodiments, the system 100 can keep a separate counter for each educational concept 104 and increment the counter corresponding to the educational concept 104 tested by each particular question 114 answered correctly during the lesson quiz.

If the system 100 determines that the counter for all the educational concepts 104 covered by the lesson 102 are above the pass threshold value, the system 100 can move to 336 and begin the next lesson 102. In some embodiments, if the system 100 determines that the counter for one or more educational concepts 104 is not above the threshold value, the system 100 can return the student to a parallel track at 308 for further study of those educational concepts 104. The student can then restart the lesson quiz at 314. In alternate embodiments, if the system 100 determines that the counter for an educational concept 104 is not above the threshold value, the system can continue presenting questions 114 that test that educational concept 104 until the student correctly answers enough questions 114 to increment the counter for that educational concept 104 above the pass threshold value for that educational concept 104.

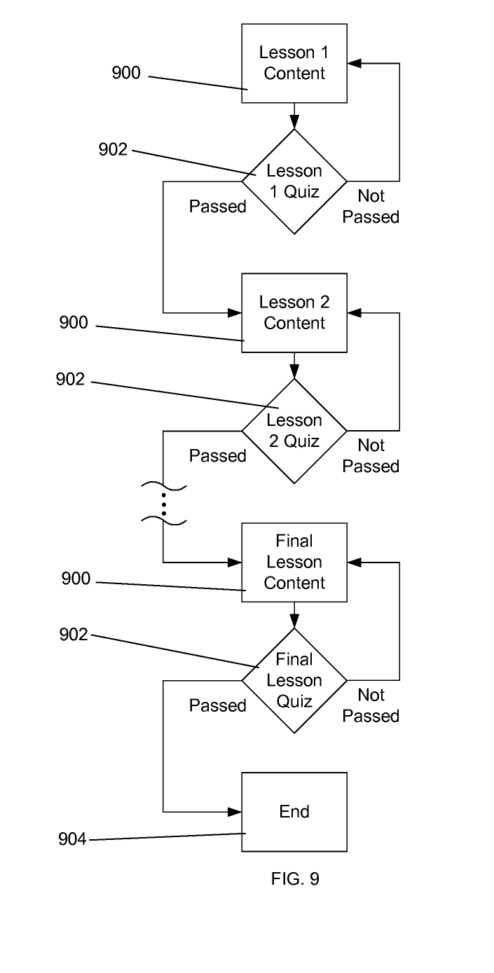

FIG. 9 depicts an alternate embodiment of the learning system 100. At 900, the system 100 can present the content of a lesson 102 to a student. In some embodiments, the content can be a core lesson track 106. In other embodiments, the content can be a textbook chapter, educational content selected by a teacher, or any other content. At 902, the system 100 can administer a lesson quiz comprising questions 114 selected to test the student's comprehension of the lesson 102. In some embodiments, when the system 100 determines that the student has not answered a question 114 correctly, the system 100 can present a positive explanation of the concepts related to that question 114 and can return to 900 to present the content for the lesson 102 to the student again. In alternate embodiments, when the system 100 determines at the completion of the lesson quiz that the student has not passed the lesson quiz by answering all, a set number, and/or a set percentage of the questions 114 correctly, the system 100 can return to 900 and present the content for the lesson 102 to the student again. After the student has reviewed the content of the lesson 102 again, the student can return to the lesson quiz at 902 for another attempt at passing the lesson quiz. When the system 100 determines at 902 that the student has answered the questions 114 and/or passed the lesson quiz, the system 100 can move to the next lesson 102 and present the content of the next lesson 102 at 900. The system 100 can continue presenting content for sequential lessons 102 at 900 and administering quizzes at 902 until the student has completed the final lesson 102 in the sequence at 904.

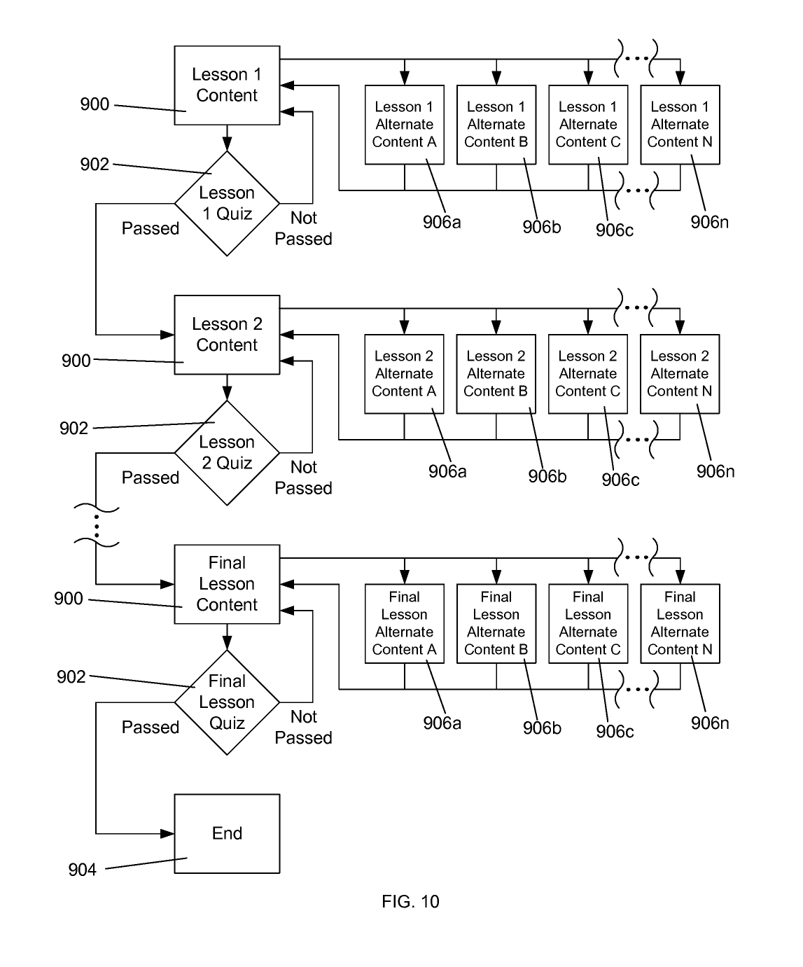

FIG. 10 depicts an alternate embodiment of the learning system 100. At 900, the system 100 can present the content of a lesson 102 to a student. In some embodiments, the content can be a core lesson track 106. In other embodiments, the content can be a textbook chapter, educational content selected by a teacher, or any other content. At 906, the system 100 can present alternate content for the lesson 102. In some embodiments, the alternate content can teach the same material in a different language. In other embodiments, the alternate content can teach the same material in a different teaching style, learning style, methodology, speed, level of depth, or any other method. In still other embodiments, the alternate content can teach supplemental material that is different from the content taught at 900. In some embodiments, the student can choose to have the system 100 present one or more of a plurality of alternate content tracks at 906a-906n. In some embodiments, the alternate content tracks can be the parallel lesson tracks 108. In other embodiments, the alternate content tracks can be the supplemental lessons 116. After presenting the alternate content at 906, the system 100 can return to 900 and present the content for the lesson 102 again.

At 902, the system 100 can administer a lesson quiz comprising questions 114 selected to test the student's comprehension of the lesson 102. In some embodiments, when the system 100 determines that the student has not answered a question 114 correctly, the system 100 can present a positive explanation of the concepts related to that question 114 and can return to 900 to present the content for the lesson 102 to the student again. In alternate embodiments, when the system 100 determines at the completion of the lesson quiz that the student has not passed the lesson quiz by answering all, a set number, and/or a set percentage of the questions 114 correctly, the system 100 can return to 900 and present the content for the lesson 102 to the student again. After the student has reviewed the content of the lesson 102 again and/or viewed any of the alternate content tracks at 906, the student can return to the lesson quiz at 902 for another attempt at passing the lesson quiz. When the system 100 determines at 902 that the student has answered the questions 114 and/or passed the lesson quiz, the system 100 can move to the next lesson 102 and present the content of the next lesson 102 at 900. The system 100 can continue presenting content for sequential lessons 102 at 900 and administering quizzes at 902 until the student has completed the final lesson 102 in the sequence at 904.

The system 100 can be presented to the student through a terminal. The terminal can be a laptop computer, desktop computer, tablet computer, e-reader, mobile phone, handheld device, or any other device capable of displaying information, accepting input, and accessing lessons. In some embodiments, the terminal can be located at a school. In other embodiments, a terminal can be located at the student's home, at a tutoring facility, or at any other location. In some embodiments, the terminal can run the system 100 as a software program or application. In alternate embodiments, the terminal can run the system 100 as a website or any other interactive form capable of presenting the system 100 to a student.

The system 100 can access and load lessons 102 from a storage device. The storage device can be a hard drive, a flash drive, a DVD, a disk, a server, or any other device capable of storing information. In some embodiments, the storage device can be a local storage device coupled with the terminal. In other embodiments, the storage device can be an external storage device separate from the terminal that the terminal can access over a network. The network can be a wired network, wireless network, local network, secured network, and/or the internet. In some embodiments, the system 100 can save each student's overall progress and/or progress in each lesson 102 to the storage device.

In some embodiments, the system 100 can be networked such that each student's progress through the lessons 102 in one or more subjects can be tracked and viewed by a supervisor. The supervisor can be a teacher, tutor, administrator, parent, guardian, or any other person who has permission to view the student's progress information. In some embodiments, the system 100 can allow a teacher to track the progress of each student in the teacher's class. The teacher can choose to use the progress information to adjust his or her teaching techniques for individual students, groups of students, or the class as a whole. By way of a non-limiting example, a teacher can use the system 100 to determine which students are progressing through the lessons 102 slowly and may need assistance, additional instruction, or tutoring outside of the system 100. By way of another non-limiting example, a teacher can use the system 100 to determine when a group of students have completed a certain lesson 102 and can choose to conduct a discussion group with those students about the lesson 102.

In some embodiments, each student's progress within the system 100 can be seen by other students. In other embodiments the system 100 can be configured to only display a percentage of the students who have completed the most lessons 102. By way of a non-limiting example, a teacher can choose to display the names of the 25% of the students in a class who have progressed the furthest through a sequence of lessons 102. In some embodiments, the system 100 can display students' progress within the system 100 to other students as part of a motivational program, a reward program, a recognition program, or any other classroom program.

In some embodiments, the system 100 can be supplemented with class discussions, homework, tests, demonstrations, projects, writing assignments, presentations, research assignments, experiments, lab work, question and answer periods, field trips, or other educational tools outside the system 100.

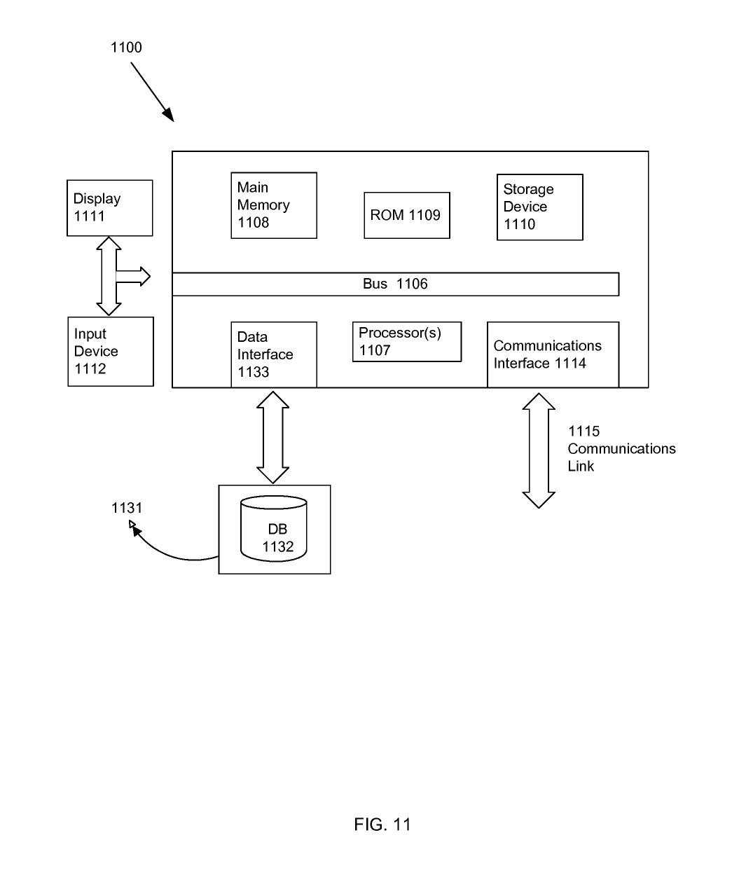

The execution of the sequences of instructions required to practice the embodiments may be performed by a computer system 1100 as shown in FIG. 11. In an embodiment, execution of the sequences of instructions is performed by a single computer system 1100. According to other embodiments, two or more computer systems 1100 coupled by a communication link 1115 may perform the sequence of instructions in coordination with one another. Although a description of only one computer system 1100 will be presented below, however, it should be understood that any number of computer systems 1100 may be employed to practice the embodiments.

A computer system 1100 according to an embodiment will now be described with reference to FIG. 11, which is a block diagram of the functional components of a computer system 1100. As used herein, the term computer system 1100 is broadly used to describe any computing device that can store and independently run one or more programs.

Each computer system 1100 may include a communication interface 1114 coupled to the bus 1106. The communication interface 1114 provides two-way communication between computer systems 1100. The communication interface 1114 of a respective computer system 1100 transmits and receives electrical, electromagnetic or optical signals, that include data streams representing various types of signal information, e.g., instructions, messages and data. A communication link 1115 links one computer system 1100 with another computer system 1100. For example, the communication link 1115 may be a LAN, in which case the communication interface 1114 may be a LAN card, or the communication link 1115 may be a PSTN, in which case the communication interface 1114 may be an integrated services digital network (ISDN) card or a modem, or the communication link 1115 may be the Internet, in which case the communication interface 1114 may be a dial-up, cable or wireless modem.

A computer system 1100 may transmit and receive messages, data, and instructions, including program, i.e., application, code, through its respective communication link 1115 and communication interface 1114. Received program code may be executed by the respective processor(s) 1107 as it is received, and/or stored in the storage device 1110, or other associated non-volatile media, for later execution.

In an embodiment, the computer system 1100 operates in conjunction with a data storage system 1131, e.g., a data storage system 1131 that contains a database 1132 that is readily accessible by the computer system 1100. The computer system 1100 communicates with the data storage system 1131 through a data interface 1133. A data interface 1133, which is coupled to the bus 1106, transmits and receives electrical, electromagnetic or optical signals, that include data streams representing various types of signal information, e.g., instructions, messages and data. In embodiments, the functions of the data interface 1133 may be performed by the communication interface 1114.

Computer system 1100 includes a bus 1106 or other communication mechanism for communicating instructions, messages and data, collectively, information, and one or more processors 1107 coupled with the bus 1106 for processing information. Computer system 1100 also includes a main memory 1108, such as a random access memory (RAM) or other dynamic storage device, coupled to the bus 1106 for storing dynamic data and instructions to be executed by the processor(s) 1107. The main memory 1108 also may be used for storing temporary data, i.e., variables, or other intermediate information during execution of instructions by the processor(s) 1107.

The computer system 1100 may further include a read only memory (ROM) 1109 or other static storage device coupled to the bus 1106 for storing static data and instructions for the processor(s) 1107. A storage device 1110, such as a magnetic disk or optical disk, may also be provided and coupled to the bus 1106 for storing data and instructions for the processor(s) 1107.

A computer system 1100 may be coupled via the bus 1106 to a display device 1111, such as, but not limited to, a cathode ray tube (CRT), for displaying information to a user. An input device 1112, e.g., alphanumeric and other keys, is coupled to the bus 1106 for communicating information and command selections to the processor(s) 1107.

According to one embodiment, an individual computer system 1100 performs specific operations by their respective processor(s) 1107 executing one or more sequences of one or more instructions contained in the main memory 1108. Such instructions may be read into the main memory 1108 from another computer-usable medium, such as the ROM 1109 or the storage device 1110. Execution of the sequences of instructions contained in the main memory 1108 causes the processor(s) 1107 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 1107. Such a medium may take many forms, including, but not limited to, non-volatile, volatile and transmission media. Non-volatile media, i.e., media that can retain information in the absence of power, includes the ROM 1109, CD ROM, magnetic tape, and magnetic discs. Volatile media, i.e., media that can not retain information in the absence of power, includes the main memory 1108. Transmission media includes coaxial cables, copper wire and fiber optics, including the wires that comprise the bus 1106. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A educational system comprising:
a plurality of lessons, each lesson comprising a core lesson track and a plurality of questions;
wherein said plurality of lessons is ordered in a sequence,
said core lesson track comprises one or more media components, and
said plurality of questions are configured to test a student's understanding of said lesson.

2. The educational system of claim 1, wherein each said lesson further comprises at least one parallel lesson track configured to teach the same material as said core lesson track through one or more different media components.

3. The educational system of claim 1, wherein each said lesson further comprises at least one supplemental lesson for each of said plurality of questions.

4. A method of education, comprising:
presenting an interactive lesson to an individual student, wherein said interactive lesson is configured to educate said individual student about one or more educational concepts;
testing said individual student's comprehension of said interactive lesson by presenting one or more questions to said individual student, wherein each question is related to one or more of said one or more educational concepts;
presenting a supplemental lesson when said individual student answers one of said questions incorrectly, wherein said supplemental lesson is configured to educate said student about the educational concepts related to the question answered incorrectly;
presenting one or more alternate questions about the educational concepts covered by said supplemental lesson; and
presenting a subsequent interactive lesson to said individual student when said individual student has correctly answered a sufficient number of said questions.

5. The educational method of claim 4, further comprising:
presenting said individual student with an option to follow a core lesson track for said lesson or to follow one or more parallel lesson tracks for said lesson, wherein said core lesson track and said parallel lesson tracks teach the same educational concepts.

6. The educational method of claim 5, wherein said one or more parallel lesson tracks are configured to teach the same educational concepts through different learning styles.

7. The educational method of claim 5, wherein said one or more parallel lesson tracks are configured to teach the same educational concepts through different teaching methods.

8. The educational method of claim 5, wherein said one or more parallel lesson tracks are configured to teach the same educational concepts through different types of media.

9. The educational method of claim 4, further comprising:
reporting the student's progress through said interactive lesson to a central database.

10. An article of manufacture comprising:
a computer-readable medium having stored thereon a data structure;
one or more core lesson track fields each containing core data representing a core lesson track comprising media components configured to teach educational concepts;
one or more parallel lesson track fields each containing parallel data representing a parallel lesson track comprising media components configured to teach said educational concepts;
one or more question bank fields each containing question data representing one or more questions configured to test said educational concepts; and
one or more supplemental lesson fields each containing supplemental data representing a supplemental lesson comprising media components configured to teach an educational concept tested by one or more said questions.

11. The article of manufacture of claim 10, wherein either of said core data or said parallel data is presented to a user in response to said user's answer to said one or more questions.

12. The article of manufacture of claim 10, wherein said supplemental data is presented to a user in response to said user's answer to said one or more questions.

13. The article of manufacture of claim 10, wherein said parallel data is presented to a user in response to an input by said user.
